(19) United States
(12) Patent Application Publication
(10) Pub. No.: US 2023/0210298 A1
(43) Pub. Date: Jul. 6, 2023

(54) Portable Water Heater Assembly

(71) Applicant: Consuelo Neri, Diamond Bar, CA (US)

(72) Inventor: Consuelo Neri, Diamond Bar, CA (US)

(21) Appl. No.: 17/565,588

(22) Filed: Dec. 30, 2021

(51) Int. Cl. A47J 27/21; F24H 1/06; F24H 1/10; F24H 1/08; F24H 15/37; C02F 5/08

(52) U.S. Cl. CPC A47J 27/21041; F24H 1/06; F24H 1/101; F24H 1/08; F24H 15/37; A47J 27/21191; A47J 27/21175; C02F 5/083; C02F 2103/02

(57) ABSTRACT

A portable water heater assembly for heating water being dispensed into a drinking glass includes a base that has a fluid reservoir integrated within the base to contain a fluid and a fill port integrated into the base. A bottle is provided to contain water and the bottle is insertable into the fill port to direct the water into the fluid reservoir. A faucet is integrated into the base to dispense the water from the fluid reservoir. A heating element is integrated into the faucet and the heating element is in thermal communication with the faucet. The heating element heats the faucet when the heating element is turned on thereby heating the water when the water flows through the faucet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to heater devices and more particularly pertains to a new heater device for heating water dispensed into a drinking cup. The device includes a base with a fluid reservoir and a salt reservoir. The device includes a bottle, which contains water, which is insertable into the fluid reservoir. The device includes a faucet which is in fluid communication with the fluid reservoir and a heating element that is integrated into the fluid reservoir. The heating element heats water dispensed by the faucet to inhibit a user from experiencing dental discomfort that could result from drinking cold water.

### (2) Description of Related Art Including Information Disclosed Under 37 CFR 1.97 and 1.98

The prior art relates to heater devices including a water supply station which includes a pair of reservoirs, being fluidly connected to each other, each containing water of a unique temperature. The prior art discloses a variety of water dispensing devices that each includes a reservoir and a filtration element for dispensing filtered water. The prior art discloses a variety of water heating devices that includes a reservoir, a heating element, a dispenser and a cup tray positioned beneath the dispenser for dispensing heated water downward into the cup tray.

### BRIEF SUMMARY OF THE INVENTION

An embodiment of the disclosure meets the needs presented above by generally comprising a base that has a fluid reservoir integrated within the base to contain a fluid and a fill port integrated into the base. A bottle is provided to contain water and the bottle is insertable into the fill port to direct the water into the fluid reservoir. A faucet is integrated into the base to dispense the water from the fluid reservoir. A heating element is integrated into the faucet and the heating element is in thermal communication with the faucet. The heating element heats the faucet when the heating element is turned on thereby heating the water when the water flows through the faucet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a portable water heater assembly according to an embodiment of the disclosure.

FIG. 2 is a left side view of an embodiment of the disclosure.

FIG. 3 is a right side phantom view of an embodiment of the disclosure.

FIG. 4 is a front phantom view of an embodiment of the disclosure.

FIG. 5 is a cross sectional view taken along line 5-5 of FIG. 4 of an embodiment of the disclosure.

### DETAILED DESCRIPTION OF THE INVENTION

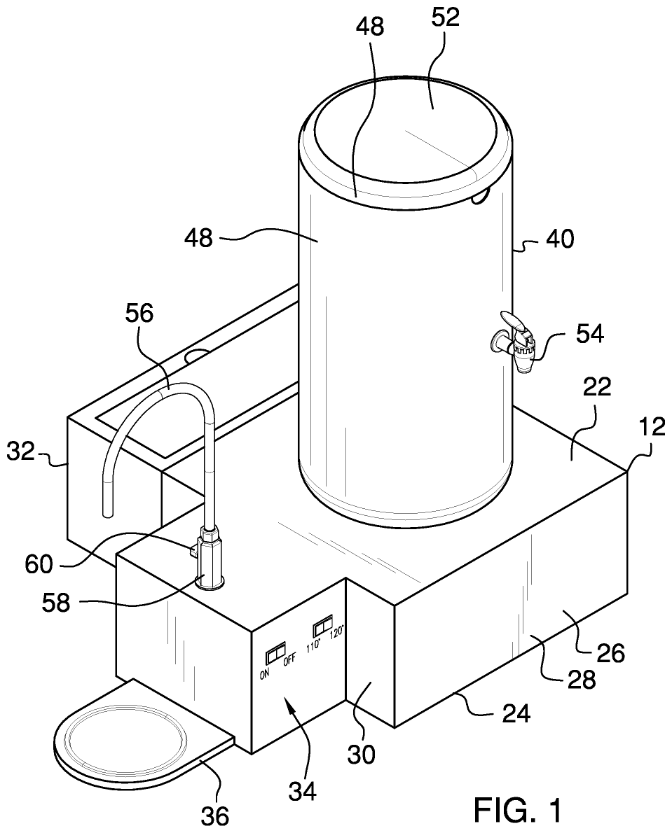

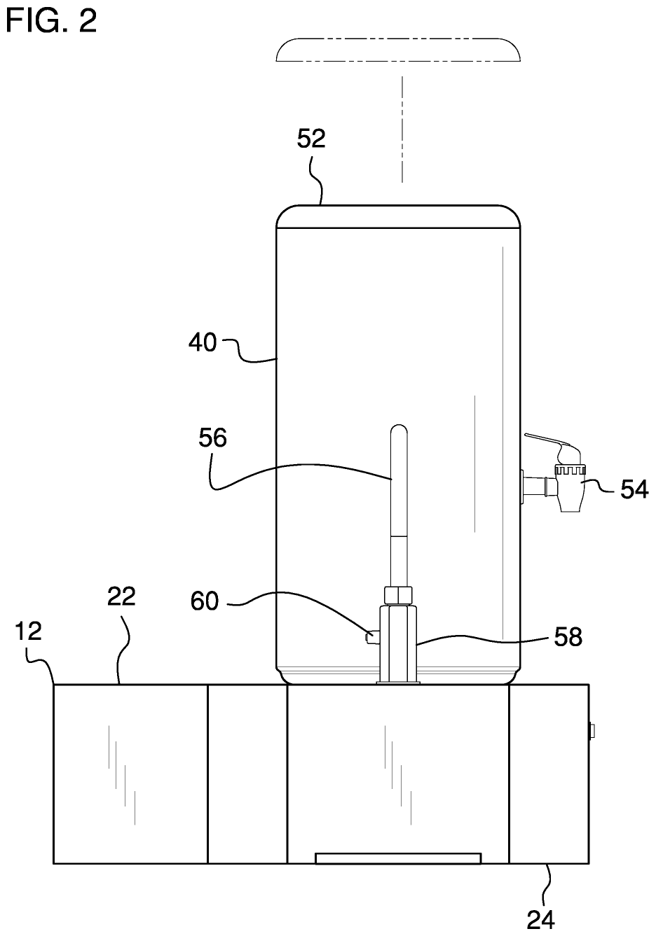

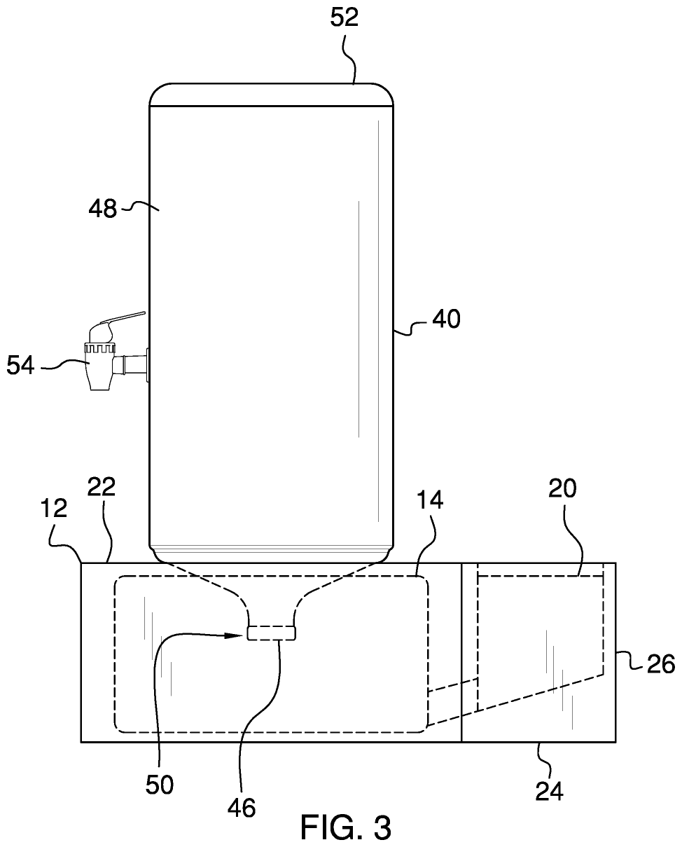

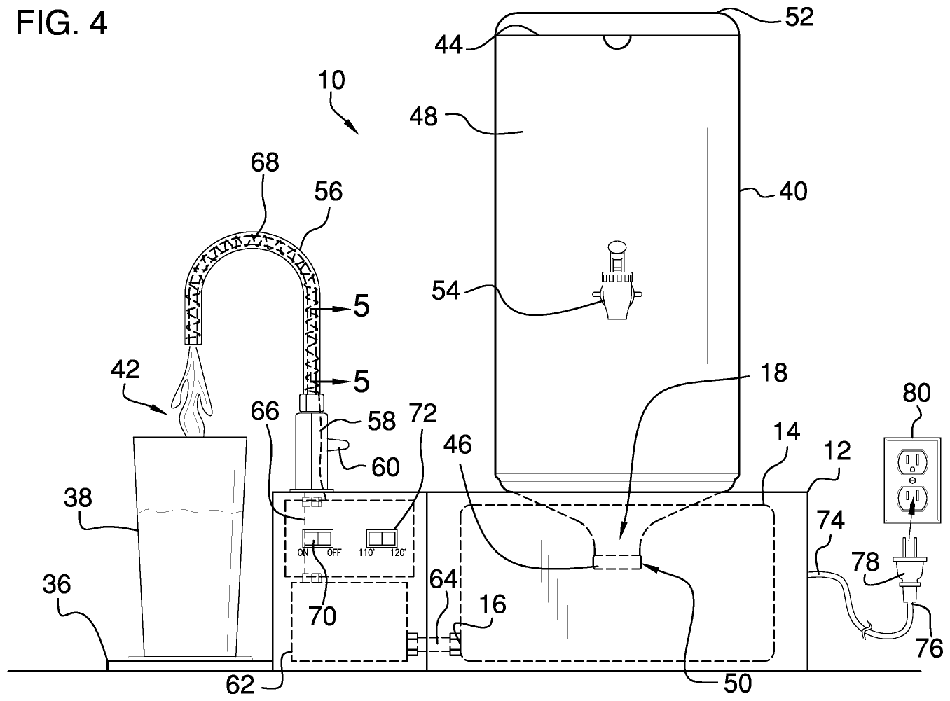

With reference now to the drawings, and in particular to FIGS. 1 through 5 thereof, a new heater device embodying the principles and concepts of an embodiment of the disclosure and generally designated by the reference numeral 10 will be described.

As best illustrated in FIGS. 1 through 5, the portable water heater assembly 10 generally comprises a base 12 that has a fluid reservoir 14 that is integrated within the base 12 to contain a fluid, and the fluid reservoir 14 has an outlet 16. The base 12 has a fill port 18 extending into the fluid reservoir 14, the base 12 has a salt well 20 extending into the base 12 to receive salt and the salt reservoir is in fluid communication with the fluid reservoir 14 for releasing salt into the fluid. The base 12 has a top wall 22, a bottom wall 24 and an outer wall 26 extending between the top wall 22 and the bottom wall 24, and the outer wall 26 has a front side 28, a first lateral side 30 and a back side 32. The base 12 has a kicked out portion 34 extending away from the first lateral side 30, and the kicked out portion 34 is positioned between the front side 28 and the back side 32.

The fill port 18 extends into the top wall 22 and the fill port 18 is positioned closer to the front side 28 than the back side 32. The salt well 20 extends into the top wall 22 and the salt well 20 is positioned adjacent to the back side 32. The kicked out portion 34 has a tray 36 extending laterally away from the kicked out portion 34 and a drinking glass 38 can be positioned on the tray 36. A bottle 40 is provided which can contain water 42 and the bottle 40 is insertable into the fill port 18 to direct the water 42 into the fluid reservoir 14. The bottle 40 has a top end 44, a bottom end 46 and an outside wall 48 extending between the top end 44 and the bottom end 46. Each of the top end 44 and the bottom end 46 is open, the outside wall 48 tapers into a spout 50 at the bottom end 46 and the fill port 18 insertably receives the spout 50.

A lid 52 is positionable on the top end 44 of the bottle 40 for closing the top end 44. A spigot 54 is integrated into the bottle 40 and the spigot 54 is actuatable into an open condition to release the water 42 from the bottle 40 for drinking. The spigot 54 is in a normally closed condition to retain the water 42 in the bottle 40. Furthermore, the spigot 54 is positioned on the outside wall 48 of the bottle 40.

A faucet 56 is integrated into the base 12 and the faucet 56 is in fluid communication with the fluid reservoir 14 to receive the water 42 from the fluid reservoir 14. The faucet 56 is actuatable into an open condition to dispense the water 42 from the fluid reservoir 14. The faucet 56 is actuatable into a closed condition to inhibit the water 42 from flowing outwardly from the faucet 56. The faucet 56 extends upwardly from the top wall 22 of the base 12 and the faucet 56 is positioned on the kicked out portion 34 of the base 12. The faucet 56 includes a valve 58 that is movably integrated into the faucet 56 and the valve 58 includes a lever 60 for manipulating the valve 58 between an open condition or a closed condition. Furthermore, the faucet 56 extends outwardly over the tray 36 to direct the water 42 into the drinking glass 38 when the drinking glass 38 is positioned on the tray 36.

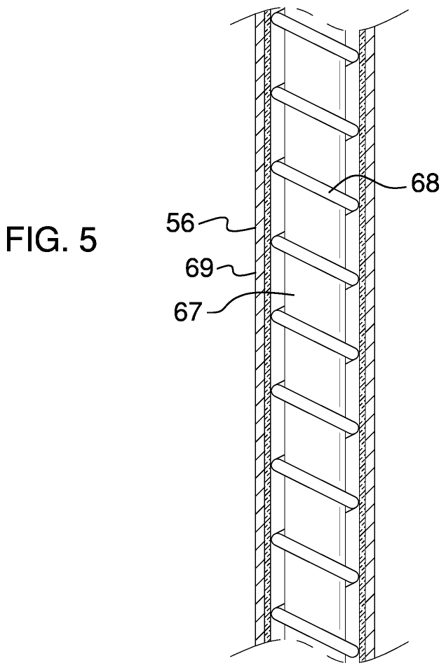

A pump 62 is integrated into the base 12 and the pump 62 has an inlet 64 and an exhaust 66. The inlet 64 is fluidly coupled to the outlet 16 of the fluid reservoir 14 to pump the water 42 in the fluid reservoir 14 outwardly through the exhaust 66 when the pump 62 is turned on. The exhaust 66 is fluidly coupled to the faucet 56 to pump the water 42 outwardly through the faucet 56. The pump 62 may comprise an electric fluid pump or the like. A heating element 68 is integrated into the faucet 56 and the heating element 68 is in thermal communication with the faucet 56. The heating element 68 heats the faucet 56 when the heating element 68 is turned on to heat the water 42 when the water 42 flows through the faucet 56. The heating element 68 may comprise an electric heating coil or the like and the heating element 68 may have an operational temperature ranging between approximately 100.0 degrees Fahrenheit and 130.0 degrees Fahrenheit. As is most clearly shown in FIG. 5, the faucet 56 may include a interior portion 67 and an outer portion 69, and the heating element 68 may be positioned between the interior portion 67 and the outer portion 69.

A power button 70 is movably integrated into the outside wall 48 of the base 12 and the power button 70 is electrically coupled to the pump 62 and the heating element 68. Each of the pump 62 and the heating element 68 is turned on when the power button 70 is positioned in an on position. Conversely, each of the pump 62 and the heating element 68 is turned off when the power button 70 is positioned in an off position. A temperature button 72 is movably integrated into the outside wall 48 of the base 12 and the temperature button 72 is electrically coupled to the heating element 68. The heating element 68 is actuated into a maximum temperature when the temperature button 72 is in a maximum position and the heating element 68 is actuated into a minimum temperature when the temperature button 72 is in a minimum position.

A power cord 74 is coupled to and extends away from the outer wall 26 of the base 12. The power cord 74 is electrically coupled to the power button 70. The power cord 74 has a distal end 76 with respect to the outer wall 26 and a male plug 78 is electrically coupled to the distal end 76. The male plug 78 can be plugged into a power source 80 comprising a female electrical outlet 16.

In use, the lid 52 is removed from the top end 44 of the bottle 40 and the bottle 40 is filled with water 42. Additionally, the salt well 20 is filled with salt for softening the water 42 that is pumped from the faucet 56. The power button 70 is positioned in the on position to turn on the pump 62 and the heating element 68. Additionally, the temperature button 72 is positioned in either the minimum position or the maximum position, depending on the user's preference. The valve 58 on the faucet 56 is positioned in the open position to dispense the water 42 into the drinking glass 38 and the heating element 68 heats the water 42 as the water 42 flows through the faucet 56. In this way the water 42 dispensed into the drinking glass 38 is warmed to inhibit the user from experiencing dental discomfort that can result from temperature sensitivity with respect to cold water 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable water heater assembly for warming water prior to drinking the water, said assembly comprising:
a base having a fluid reservoir being integrated within said base wherein said fluid reservoir is configured to contain a fluid, said base having a fill port extending into said fluid reservoir, said base having a salt well extending into said base wherein said salt well is configured to receive salt;
a bottle being configured to contain water, said bottle being insertable into said fill port wherein said fill port is configured to direct the water into said fluid reservoir;
a faucet being integrated into said base, said faucet being in fluid communication with said fluid reservoir wherein said faucet is configured to receive the water from said fluid reservoir, said faucet being actuatable into an open condition wherein said faucet is configured to dispense the water from said fluid reservoir, said faucet being actuatable into a closed condition wherein said faucet is configured to inhibit the water from flowing outwardly from said faucet; and
a heating element being integrated into said faucet, said heating element being in thermal communication with said faucet, said heating element heating said faucet when said heating element is turned on wherein said heating element is configured to heat the water when the water flows through said faucet.

2. The assembly according to claim 1, wherein said base has a top wall, a bottom wall and an outer wall extending between said top wall and said bottom wall, said outer wall having a front side, a first lateral side and a back side, said base having a kicked out portion extending away from said first lateral side, said kicked out portion being positioned between said front side and said back side, said fill port extending into said top wall, said fill port being positioned closer to said front side than said back side, said salt well extending into said top wall, said salt well being positioned adjacent to said back side, said fluid reservoir having an outlet, said kicked out portion having a tray extending laterally away from said kicked out portion wherein said tray is configured to have a drinking glass positioned on said tray.

3. The assembly according to claim 2, wherein:
said bottle has a top end, a bottom end and an outside wall extending between said top end and said bottom end, each of said top end and said bottom end being open, said outside wall tapering into a spout at said bottom end, said fill port insertably receiving said spout; and
said assembly includes a lid being positionable on said top end of said bottle for closing said top end.

4. The assembly according to claim 3, further comprising a spigot being integrated into said bottle, said spigot being actuatable into an open condition wherein said spigot is configured to release the water from said bottle for drinking, said spigot being in a normally closed condition wherein said spigot is configured to retain the water in said bottle, said spigot being positioned on said outside wall of said bottle.

5. The assembly according to claim 2, wherein said faucet extends upwardly from said top wall of said base, said faucet being positioned on said kicked out portion of said base, said faucet including a valve being movably integrated into said faucet, said valve including a lever for manipulating said valve between an open condition or a closed condition, said faucet extending outwardly over said tray wherein said faucet is configured to direct the water into the drinking glass when the drinking glass is positioned on said tray.

6. The assembly according to claim 1, further comprising a pump being integrated into said base, said pump having an inlet and an exhaust, said inlet being fluidly coupled to said fluid reservoir wherein said pump is configured to pump the water in said fluid reservoir outwardly through said exhaust when said pump is turned on, said exhaust being fluidly coupled to said faucet wherein said pump is configured to pump the water outwardly through said faucet.

7. The assembly according to claim 6, further comprising a power button being movably integrated into said base, said power button being electrically coupled to said pump and said heating element, each of said pump and said heating element being turned on when said power button is positioned in an on position, each of said pump and said heating element being turned off when said power button is positioned in an off position.

8. The assembly according to claim 2, further comprising a temperature button being movably integrated into said outside wall of said base, said temperature button being electrically coupled to said heating element, said heating element being actuated into a maximum temperature when said temperature button is in a maximum position, said heating element being actuated into a minimum temperature when said temperature button is in a minimum position.

9. The assembly according to claim 7, further comprising a power cord being coupled to and extending away from said outer wall of said base, said power cord being electrically coupled to said power button, said power cord having a distal end with respect to said outer wall, said distal end having a male plug being electrically coupled to said distal end wherein said male plug is configured to be plugged into a power source comprising a female electrical outlet.

10. A portable water heater assembly for warming water prior to drinking the water, said assembly comprising:
a base having a fluid reservoir being integrated within said base wherein said fluid reservoir is configured to contain a fluid, said base having a fill port extending into said fluid reservoir, said base having a salt well extending into said base wherein said salt well is configured to receive salt, said base having a top wall, a bottom wall and an outer wall extending between said top wall and said bottom wall, said outer wall having a front side, a first lateral side and a back side, said base having a kicked out portion extending away from said first lateral side, said kicked out portion being positioned between said front side and said back side, said fill port extending into said top wall, said fill port being positioned closer to said front side than said back side, said salt well extending into said top wall, said salt well being positioned adjacent to said back side, said fluid reservoir having an outlet, said kicked out portion having a tray extending laterally away from said kicked out portion wherein said tray is configured to have a drinking glass positioned on said tray;
a bottle being configured to contain water, said bottle being insertable into said fill port wherein said fill port is configured to direct the water into said fluid reservoir, said bottle having a top end, a bottom end and an outside wall extending between said top end and said bottom end, each of said top end and said bottom end being open, said outside wall tapering into a spout at said bottom end, said fill port insertably receiving said spout;
a lid being positionable on said top end of said bottle for closing said top end;
a spigot being integrated into said bottle, said spigot being actuatable into an open condition wherein said spigot is configured to release the water from said bottle for drinking, said spigot being in a normally closed condition wherein said spigot is configured to retain the water in said bottle, said spigot being positioned on said outside wall of said bottle;
a faucet being integrated into said base, said faucet being in fluid communication with said fluid reservoir wherein said faucet is configured to receive the water from said fluid reservoir, said faucet being actuatable into an open condition wherein said faucet is configured to dispense the water from said fluid reservoir, said faucet being actuatable into a closed condition wherein said faucet is configured to inhibit the water from flowing outwardly from said faucet, said faucet extending upwardly from said top wall of said base, said faucet being positioned on said kicked out portion of said base, said faucet including a valve being movably integrated into said faucet, said valve including a lever for manipulating said valve between an open condition or a closed condition, said faucet extending outwardly over said tray wherein said faucet is configured to direct the water into the drinking glass when the drinking glass is positioned on said tray;
a pump being integrated into said base, said pump having an inlet and an exhaust, said inlet being fluidly coupled to said fluid reservoir wherein said pump is configured to pump the water in said fluid reservoir outwardly through said exhaust when said pump is turned on, said exhaust being fluidly coupled to said faucet wherein said pump is configured to pump the water outwardly through said faucet;
a heating element being integrated into said faucet, said heating element being in thermal communication with said faucet, said heating element heating said faucet when said heating element is turned on wherein said heating element is configured to heat the water when the water flows through said faucet;
a power button being movably integrated into said outside wall of said base, said power button being electrically coupled to said pump and said heating element, each of said pump and said heating element being turned on when said power button is positioned in an on position, each of said pump and said heating element being turned off when said power button is positioned in an off position;
a temperature button being movably integrated into said outside wall of said base, said temperature button being electrically coupled to said heating element, said heating element being actuated into a maximum temperature when said temperature button is in a maximum position, said heating element being actuated into a minimum temperature when said temperature button is in a minimum position; and
a power cord being coupled to and extending away from said outer wall of said base, said power cord being electrically coupled to said power button, said power cord having a distal end with respect to said outer wall, said distal end having a male plug being electrically coupled to said distal end wherein said male plug is configured to be plugged into a power source comprising a female electrical outlet.
